(19) United States
(12) Patent Application Publication
(10) Pub. No.: US 2026/0303245 A1
(43) Pub. Date: Oct. 1, 2026

(54) SECONDARY REFERENCE TIME VALIDATION

(71) Applicant: Nokia Solutions and Networks Oy, Espoo (FI)

(72) Inventors: Vinoth GOWTHAMAN, Ottawa (CA); Renuka RANI, Ottawa (CA); Peter ROBERTS, Ottawa (CA); Kin Yee WONG, Ottawa (CA)

(73) Assignee: Nokia Solutions and Networks Oy, Espoo (FI)

(21) Appl. No.: 19/089,748

(22) Filed: Mar. 25, 2025

(51) Int. Cl. H04J 3/06

(52) U.S. Cl. CPC H04J 3/0667; H04J 3/0673; H04J 3/0697

(57) ABSTRACT

A node in a computer network receives signals for at least first and second reference times, selects (i) the first reference time to be a primary reference time for the node's ongoing operations and (ii) the second reference time to be a secondary reference time, calculates an offset value between the secondary reference time and the primary reference time, determines whether the secondary reference time is valid based on the calculated offset value, and, if valid, uses the secondary reference time for its ongoing operations upon loss of the primary reference time. If not valid, then the secondary reference time is not used. If multiple secondary reference times are available, the node validates and prioritizes the secondary reference times, based on corresponding calculated offset values, for use upon loss of the primary reference time.

### BACKGROUND

### Field of the Disclosure

The present disclosure relates to computer networks having multiple available reference times.

### Description of the Related Art

This section introduces aspects that may help facilitate a better understanding of the disclosure. Accordingly, the statements of this section are to be read in this light and are not to be understood as admissions about what is prior art or what is not prior art.

It is known for a node in a computer network to have one or more different available reference times. For example, a node may receive a first reference time from a Global Navigation Satellite System (GNSS) and a second reference time from a Precision Time Protocol (PTP) grandmaster of a PTP clock-distribution system conforming to the IEEE Std 1588™-2008 (or its revised version of IEEE Std 1588™-2019) standard, the teachings of which are incorporated herein by reference.

It is also known for the node to select one of the available reference times as its primary reference time for its ongoing operations, while designating the other available reference time as its secondary reference time. In the case of PTP, this would be done using a Best Time Transmitting Clock Algorithm (BTCA). It is further known for the node to calculate and update the offset between the primary and secondary reference times over time, such that, if and when the node loses the primary reference time, the node can switch its ongoing operations to rely on the secondary reference time, taking into account the current, calculated offset to avoid a discontinuity in its ongoing reference time.

### SUMMARY

There may be situations where the magnitude of the calculated offset between a node's primary and secondary reference times is too large to be used to employ the secondary reference time in the event of loss of the primary reference time. For example, some applications that are sensitive to variations may limit time corrections (sudden jumps) due to a reference switch. To avoid those situations, in some embodiments, a node thresholds the calculated offset between its primary and secondary reference times to determine whether the secondary reference time is qualified to be used as the node's ongoing reference time in the event of loss of the primary reference time. If the calculated offset is less than or equal to a specified maximum offset limit, then the secondary reference time is validated for potential use, and the node will switch to the secondary reference time taking into account the calculated offset upon loss of the primary reference time. Otherwise, the calculated offset is too large and the secondary reference time is not validated for potential use. In that case, upon loss of the primary reference time, the node will not switch to the secondary reference time, but will instead transition to a holdover mode until a sufficiently accurate reference time is subsequently received.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a block diagram of a computer network according to certain embodiments of the disclosure;

FIG. 2 is a flow diagram of the processing of node 130 of FIG. 1 according to possible scenarios in which the primary (GNSS-based) reference time is eventually lost; and

FIG. 3 is a simplified hardware block diagram of an example node that can be used to implement any of the nodes 110, 120, and 130 of FIG. 1.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

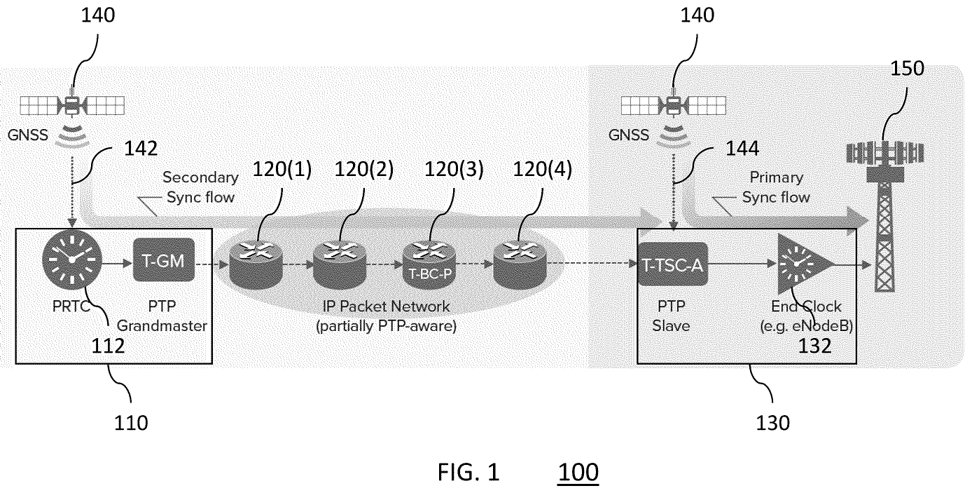

FIG. 1 is a block diagram of a computer network 100 according to certain embodiments of the disclosure. As shown in FIG. 1, node 130 functions as the time reference for (e.g., eNodeB) base station 150 by providing end clock 132 to the base station. In the situation depicted in FIG. 1, node 130 has selected the GNSS system 140 as its primary time reference and uses signals 144 received directly from the GNSS system 140 to generate end clock 132.

In addition, node 130 is a PTP time receiver that receives PTP time as its secondary reference time. In particular, node 110 functions as a PTP grandmaster for a PTP clock-distribution system that includes PTP-grandmaster node 110, intermediate nodes 120(1)-120(4), and PTP time-receiver node 130. As shown in FIG. 1, node 110 generates its PTP reference time clock 112 based on signals 142 that node 110 receives directly from the GNSS system 140. In the particular example of network 100 of FIG. 1, the PTP system is a partially PTP-aware system in which intermediate nodes 120(1), 120(2), and 120(4) are not PTP aware (i.e., they are PTP unaware), while intermediate node 120(3) is PTP aware.

As known in the art, a PTP-unaware intermediate node merely passes PTP messages without establishing its own reference time for downstream nodes, while a PTP-aware intermediate node will use the PTP messages to establish its own reference time for downstream nodes. Thus, in the example network 100 of FIG. 1, the PTP-grandmaster node 110 is the PTP time reference for intermediate nodes 120(1)-120(3), while PTP-aware intermediate node 120(3) establishes its own reference time and is the PTP time reference for PTP-unaware intermediate node 120(4) and node 130.

Those skilled in the art will understand that, in general, a PTP clock-distribution system may be either (i) fully PTP aware in which case each intermediate node is PTP aware, (i) partially PTP aware in which case one or more intermediate nodes are PTP aware and one or more other intermediate nodes are PTP unaware, or (iii) fully PTP unaware in which case each intermediate node is PTP unaware.

In any case, node 130 receives appropriate PTP messages of the PTP clock-distribution system, maintains a PTP clock as its secondary reference time, calculates the current offset between that secondary (i.e., PTP-based) reference time and its primary (i.e., GNSS-based) reference time, and thresholds the current offset against a specified maximum current offset limit to determine whether the secondary reference time is validated to use in the event of loss of the primary reference time.

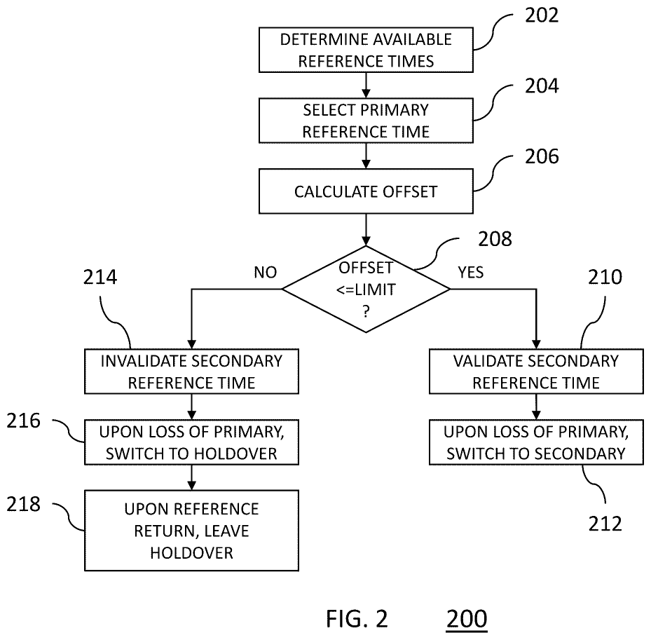

FIG. 2 is a flow diagram of the processing 200 of node 130 of FIG. 1 according to possible scenarios in which the primary (GNSS-based) reference time is eventually lost.

In step 202, node 130 determines that reference times are available from both the GNSS system 140 directly and the PTP time-reference system of FIG. 1.

In step 204, node 130 selects the GNSS-based reference time as its primary reference time and the PTP-based reference time as its secondary reference time.

In step 206, node 130 calculates the offset between its primary, GNSS-based reference time and its secondary, PTP-based reference time.

In step 208, node 130 compares the calculated offset value to its specified maximum offset limit. If node 130 determines that the calculated offset value is less than or equal to the limit, then, in step 210, node 130 validates the secondary, PTP-based reference time for use in the event of loss of the primary, GNSS-based reference time (e.g., due loss of GNSS signal 144), as in step 212. Otherwise, in step 214, the secondary, PTP-based reference time is not validated for use in the event of loss of the primary, GNSS-based reference time, in which case, node 130 proceeds to operate in a holdover mode using the last received GNSS-based reference time to generate its end clock 132, as in step 216. In step 218, node 130 leaves the holdover mode when a subsequent, sufficiently accurate reference time becomes available again, as determined by calculating and thresholding the offset between that subsequent reference time and the ongoing holdover clock. That subsequent reference time may result from the return of the GNSS signal 144 or the provision of a completely different time reference.

Note that steps 206 and 208 are repeated over time to maintain current offset values and make up-to-date validation decisions for the secondary reference time.

The disclosure has been described in the context of the node 130 of FIG. 1, which compares the calculated offset value to a specified maximum offset limit to determine whether the secondary reference time is validated.

Although the disclosure has been described in the context of the situation of FIG. 1 in which the GNSS-based reference time is the primary reference time and the PTP-based reference time is the secondary reference time, in other situations, the roles may be reversed. Furthermore, in general, embodiments of the disclosure may involve two or more different available reference times based on any suitable time references, where one of the available reference times is selected as the primary reference time and the one or more other available reference times are secondary reference times. In situations in which there are three or more different available reference times, the node may calculate multiple different offsets between the primary reference time and the respective, multiple secondary reference times, threshold each offset value to validate or invalidate the corresponding secondary reference time, and prioritize the validated secondary reference times, where smaller offset values have higher priorities, for possible use upon loss of the primary reference time.

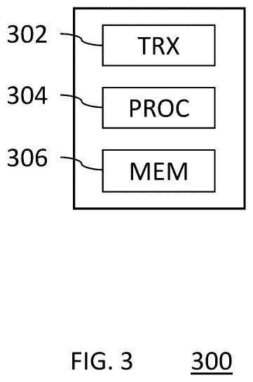

FIG. 3 is a simplified hardware block diagram of an example node 300 that can be used to implement any of the nodes 110, 120, and 130 of FIG. 1. As shown in FIG. 3, the node 300 includes (i) communication hardware (e.g., wireless, wireline, and/or optical transceivers (TRX)) 302 that supports communications with other nodes, (ii) one or more processors (e.g., CPU and/or GPU microprocessors) 304 that control the operations of the node 300 and/or process data within the node 300, and (iii) one or more memories (e.g., RAM, ROM) 306 that store code executed by the processors 304 and/or data generated and/or received by the node 300.

In certain embodiments, the present disclosure is a node for a computer network. The node comprises at least one processor and at least one memory storing instructions that, upon being executed by the at least one processor, cause the node at least to receive signals for at least first and second reference times; select (i) the first reference time to be a primary reference time for the node's ongoing operations and (ii) the second reference time to be a secondary reference time; calculate an offset value between the secondary reference time and the primary reference time; and determine whether the secondary reference time is valid based on the calculated offset value.

In at least some of the above embodiments, the node is configured to compare the calculated offset value to a specified maximum offset limit to determine whether the secondary reference time is valid.

In at least some of the above embodiments, upon detection of loss of the primary reference time, the node is configured to switch to a valid secondary reference time, but not to an invalid secondary reference time.

In at least some of the above embodiments, one of the first and second reference times is a satellite-based reference time.

In at least some of the above embodiments, one of the first and second reference times is a PTP-based reference time of a PTP clock-distribution system.

In at least some of the above embodiments, the node is configured to receive signals for three or more reference times; select (i) one of the reference times to be the primary reference time for the node's ongoing operations and (ii) the remaining two or more reference times to be secondary reference times; calculate an offset value between each secondary reference time and the primary reference time; and determine whether each secondary reference time is valid based on the calculated offset value.

In at least some of the above embodiments, the node is configured to prioritize the two or more secondary reference times based on the corresponding calculated offset values and, upon detection of loss of the primary reference time, switch to a valid secondary reference time having highest priority.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A node for a computer network, the node comprising:
at least one processor; and
at least one memory storing instructions that, upon being executed by the at least one processor, cause the node at least to:
receive signals for at least first and second reference times;
select (i) the first reference time to be a primary reference time for the node's ongoing operations and (ii) the second reference time to be a secondary reference time;
calculate an offset value between the secondary reference time and the primary reference time; and
determine whether the secondary reference time is valid based on the calculated offset value.

2. The node of claim 1, wherein the node is configured to compare the calculated offset value to a specified maximum offset limit to determine whether the secondary reference time is valid.

3. The node of claim 1, wherein, upon detection of loss of the primary reference time, the node is configured to switch to a valid secondary reference time, but not to an invalid secondary reference time.

4. The node of claim 1, wherein one of the first and second reference times is a satellite-based reference time.

5. The node of claim 1, wherein one of the first and second reference times is a PTP-based reference time of a Precision Time Protocol (PTP) clock-distribution system.

6. The node of claim 1, wherein the node is configured to:
receive signals for three or more reference times;
select (i) one of the reference times to be the primary reference time for the node's ongoing operations and (ii) the remaining two or more reference times to be secondary reference times;
calculate an offset value between each secondary reference time and the primary reference time; and
determine whether each secondary reference time is valid based on the calculated offset value.

7. The node of claim 6, wherein the node is configured to:
prioritize the two or more secondary reference times based on the corresponding calculated offset values; and
upon detection of loss of the primary reference time, switch to a valid secondary reference time having highest priority.

8. A method for a node for a computer network, the method comprising the node:
receiving signals for at least first and second reference times;
selecting (i) the first reference time to be a primary reference time for the node's ongoing operations and (ii) the second reference time to be a secondary reference time;
calculating an offset value between the secondary reference time and the primary reference time; and
determining whether the secondary reference time is valid based on the calculated offset value.

9. The method of claim 8, wherein the node compares the calculated offset value to a specified maximum offset limit to determine whether the secondary reference time is valid.

10. The method of claim 8, wherein, upon detection of loss of the primary reference time, the node switches to a valid secondary reference time, but not to an invalid secondary reference time.

11. The method of claim 8, wherein one of the first and second reference times is a satellite-based reference time.

12. The method of claim 8, wherein one of the first and second reference times is a PTP-based reference time of a PTP clock-distribution system.

13. The method of claim 8, wherein the node:
receives signals for three or more reference times;
selects (i) one of the reference times to be the primary reference time for the node's ongoing operations and (ii) the remaining two or more reference times to be secondary reference times;
calculates an offset value between each secondary reference time and the primary reference time; and
determines whether each secondary reference time is valid based on the calculated offset value.

14. The method of claim 13, wherein the node:
prioritizes the two or more secondary reference times based on the corresponding calculated offset values; and
upon detection of loss of the primary reference time, switches to a valid secondary reference time having highest priority.
